(19) United States
(12) Patent Application Publication
(10) Pub. No.: US 2018/0227430 A1
(43) Pub. Date: Aug. 9, 2018

(54) CONVERGED COMMUNICATION DEVICE

(71) Applicant: BLUEWAVE GLOBAL INNOVATIONS, PTE. LTD., One Fullerton (SG)

(72) Inventor: DON DERRICK DAVID RIVERA CRUZ, III, QUEZON CITY (PH)

(21) Appl. No.: 15/932,536

(22) PCT Filed: Jul. 11, 2016
(86) PCT No.: PCT/IB2016/001020

§ 371 Date: Mar. 12, 2018

(30) Foreign Application Priority Data
Mar. 1, 2016 (PH) 12016000086

(51) Int. Cl. H04M 7/12; H04M 1/253; H04M 1/04; H04M 1/02; H04M 1/725

(52) U.S. Cl. CPC H04M 7/125; H04M 1/2535; H04M 1/72502; H04M 1/0202; H04M 1/04

(57) ABSTRACT

The present invention is a converged communication device that extends the landline voice service beyond the confines of the home to smartphones and other smart devices. The converged communication device includes a handset, a tablet, a VoIP softphone and a docking station. The docking station, which connects to PSTN and is wirelessly connected to the handset and tablet, communicates with the tablet that has the VoIP softphone installed such that the capability of making and receiving calls via the landline is extended beyond the confines of the home to the tablet or any other registered smart device.

### FIELD OF THE INVENTION

The invention relates to the field of communication devices, and more particularly to converged communication devices.

### BACKGROUND OF THE INVENTION

Conventionally, landline phones are used exclusively for voice communications. With the introduction of mobile phones that offer a myriad of features on top of being highly portable, there has been a drastic decline in landline subscriptions.

To address such issue, some manufacturers came up with a device that integrated a touchscreen tablet in a landline phone unit. The device consists of an analog phone and a tablet. In the said device, the analog phone also serves as a dock for charging the tablet. When the tablet is removed from the dock, calls are made by lifting the handset and using the physical keypad just like an ordinary fixed phone. When the tablet is docked, calls are made by lifting the handset and using the onscreen dialer shown in the docked tablet.

In the device of the prior art, the tablet merely serves as an onscreen dialer and it needs to be docked in order to serve such function. Moreover, landline calls con only be received at the place where the device is installed.

Thus, it is desirable to provide a converged communication device that is able to extend the landline voice service beyond the confines of the home to smartphones and other smart devices.

### SUMMARY OF THE INVENTION

The primary object therefore of the present invention is to remedy the aforementioned drawbacks by providing a converged communication device that extends the landline voice service beyond the confines of the home to smartphones and other smart devices. The present invention includes a handset, a tablet, a Voice over Internet Protocol (VoIP) softphone and a docking station. The docking station connects to Public Switched Telephone Network (PSTN) and is wirelessly connected to the handset and tablet. The docking station communicates with the tablet that has the VoIP softphone installed such that the capability of making and receiving calls via the landline is extended to the tablet or any other registered smart device. Moreover, the calls con be transferred from the handset to the tablet or any other registered smart device and vice-versa. With the present invention, it is possible to use the tablet to make and receive calls via the landline regardless of the tablet's docking state. Another object of this invention is to provide a converged communication device that is durable and convenient to use.

### BRIEF DESCRIPTION OF THE DRAWINGS

FIG. 1 is a front view of the converged communication device embodying the subject invention;

FIG. 2 is a side view of FIG. 1;

FIG. 3 is a block diagram of the docking station together with the supporting components and the network environment;

FIG. 4 is a sequence diagram illustrating a call from PSTN to a registered smart device outside the subscriber's home;

FIG. 5 is a sequence diagram illustrating a call from a registered smart device outside the subscriber's home to PSTN;

FIG. 6 is a sequence diagram illustrating a call from PSTN to subscriber's home;

FIG. 7 is a sequence diagram illustrating a call from subscriber's home to PSTN;

FIG. 8 is a sequence diagram illustrating a call from handset to tablet within the subscriber's home;

FIG. 9 is a sequence diagram illustrating a call from subscriber's home to a registered smart device outside; and

FIG. 10 is a sequence diagram illustrating a call from a registered smart device outside to subscriber's home.

### DETAILED DESCRIPTION OF THE INVENTION

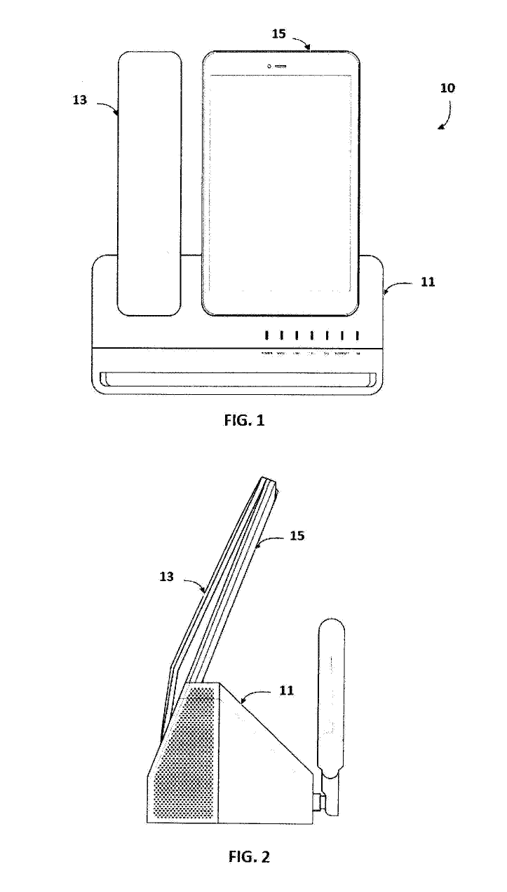

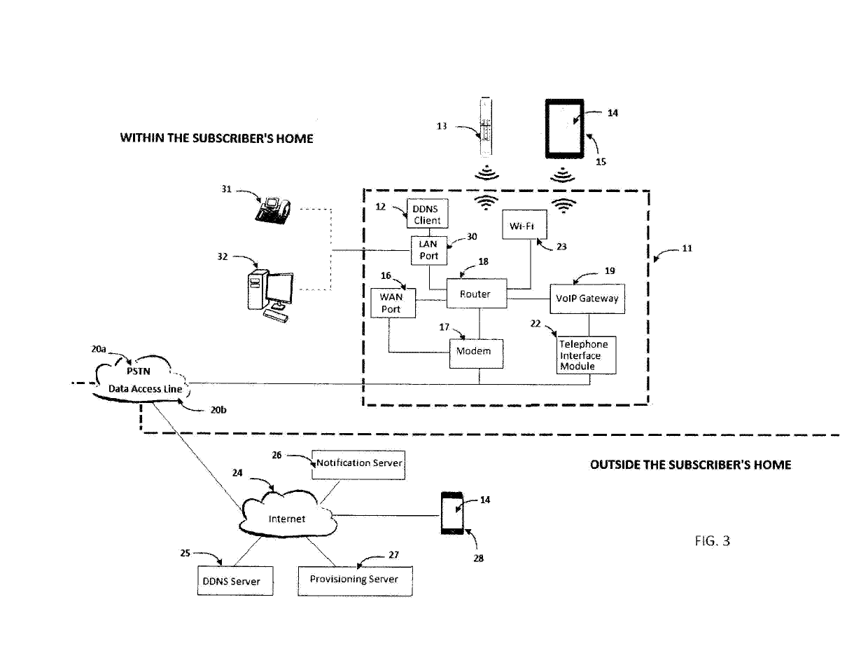

Referring now to the drawings in detail wherein like numerals designate the same port throughout, there is shown in the drawings particularly in FIG. 1, a converged communication device generally designated as 10, that extends the landline voice service beyond the confines of the home to smartphones and other smart devices. The converged communication device 10 includes a handset 13, a tablet 15, a VoIP softphone 14 and a docking station 11. The docking station 11 connects to PSTN 20a and is wirelessly connected to the handset 13 and tablet 15. The docking station 11 communicates with the tablet 15 that has the VoIP softphone 14 installed such that the capability of making and receiving calls via the landline is extended beyond the confines of the home to the tablet 15 or to a registered smart device 28. Since the tablet 15 has the the VoIP softphone 14 installed, it is possible to make and receive calls via the landline regardless of the docking state of the tablet 15.

The docking station 11 integrates the functions of modem 17, router 18 and VoIP gateway 19.

The docking station 11 has a Wide Area Network (WAN) port 16 that serves as connection point for Internet sources via RJ45 connector in case of opting not to use the built-in internal modem 17. The docking station 11 is designed in such a way that it con accommodate the handset 13 and tablet 15 on their respective docking areas at the same time.

In use cases:

For a call from PSTN to a registered smart device outside the subscriber's home as shown in FIGS. 3 and 4, the call from PSTN 200 enters the telephone interface module 22 that receives the voice signal and converts it into a digital signal suitable for processing by the VoIP gateway 19. Configuration setting is done in the VoIP gateway 19 such that the registered smart device 28 is the device that accepts an incoming coll. The VoIP gateway 19 receives the digital signal from the telephone interface module 22, converts it into data packets and sends these data packets to the router 18. The router 18 forwards the data packets to the modem 17. The modem 17 converts the digital data into a suitable signal to be sent to the Internet 24 via data access line 20b. Data access line 20b refers to the means by which Internet access is delivered to the subscriber. Data access line 20b includes but is not limited to Digital Subscriber Line (DSL), cable Internet and fiber optic Internet. The registered smart device 28 communicates with the Dynamic Domain Name System (DDNS) server 25 to retrieve the Internet Protocol (IP) address of the VoIP gateway 19. The call to the registered smart device 28 is progressed via the Internet 24 (for easy reference, see the number of arrowheads 1-8).

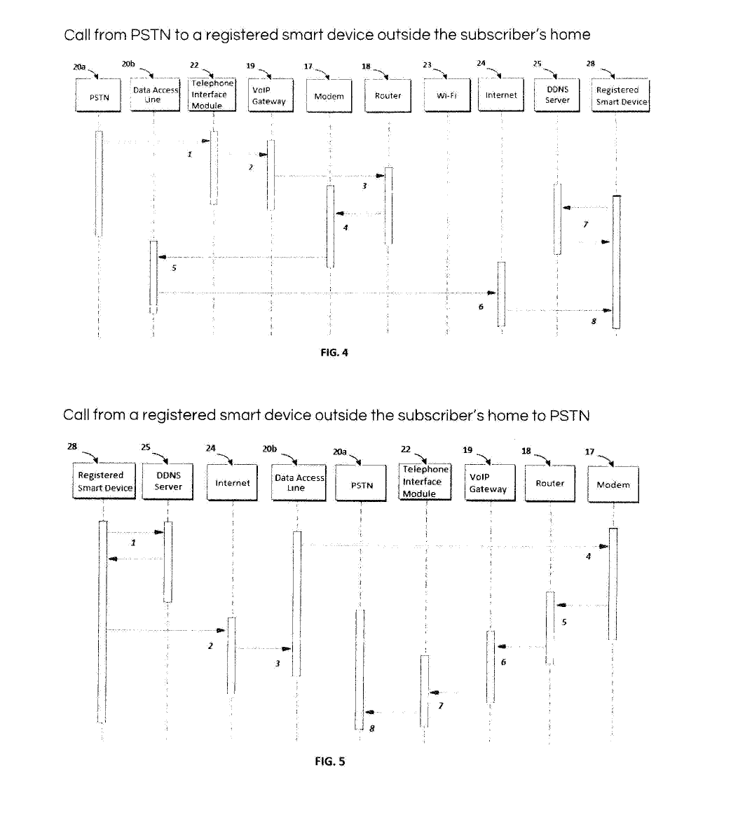

For a call from a registered smart device outside the subscriber's home to PSTN as shown in FIGS. 3 and 5, the registered smart device 28 communicates with the DDNS server 25 to retrieve the IP address of the VoIP gateway 19. The call from the registered smart device 28 is sent to the Internet 24. The modem 17 receives the data via data access line 20b and sends it to the router 18. The router 18 forwards the digital signal to the VoIP gateway 19. The VoIP gateway 19 sends the digital signal to the telephone interface module 22. The telephone interface module 22 converts the digital signal into voice signal to be received by PSTN 20a (for easy reference, see the number of arrowheads 1-8).

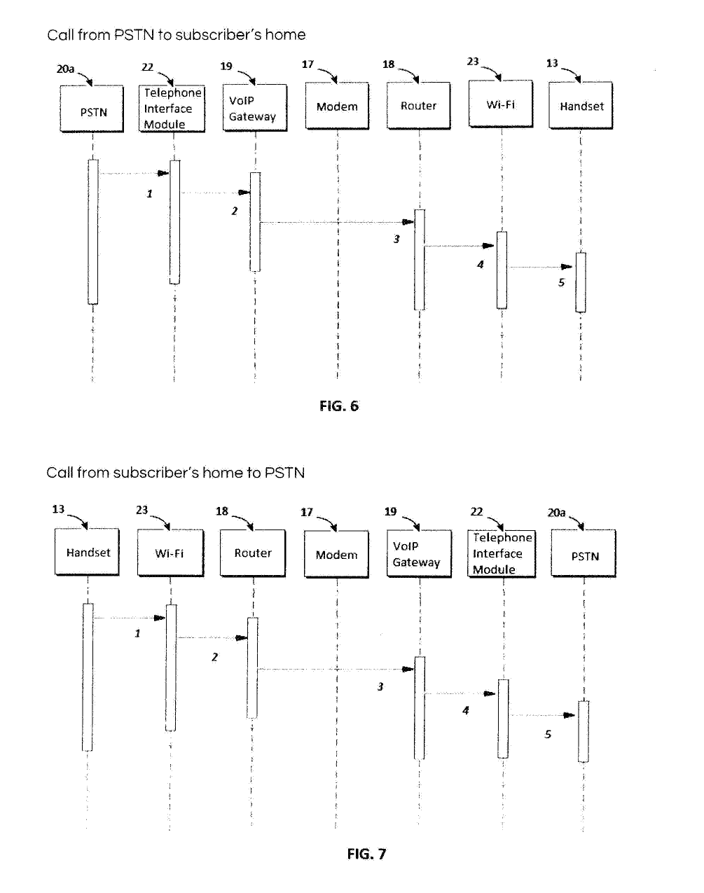

For a call from PSTN to subscriber's home as shown in FIGS. 3 and 6, the call from PSTN 20a enters the telephone interface module 22 that receives the voice signal and converts it into a digital signal suitable for processing by the VoIP gateway 19. The VoIP gateway 19 is configured to assign which device should accept an incoming call. In this case, the handset 13 is assigned as the device that accepts the incoming call. The VoIP gateway 19 converts the digital signals into data packets and sends them to the router 18. The router 18 receives these data packets and sends them to the handset 13 through Wi-Fi 23 and the call is progressed (for easy reference, see the number of arrowheads 1-5).

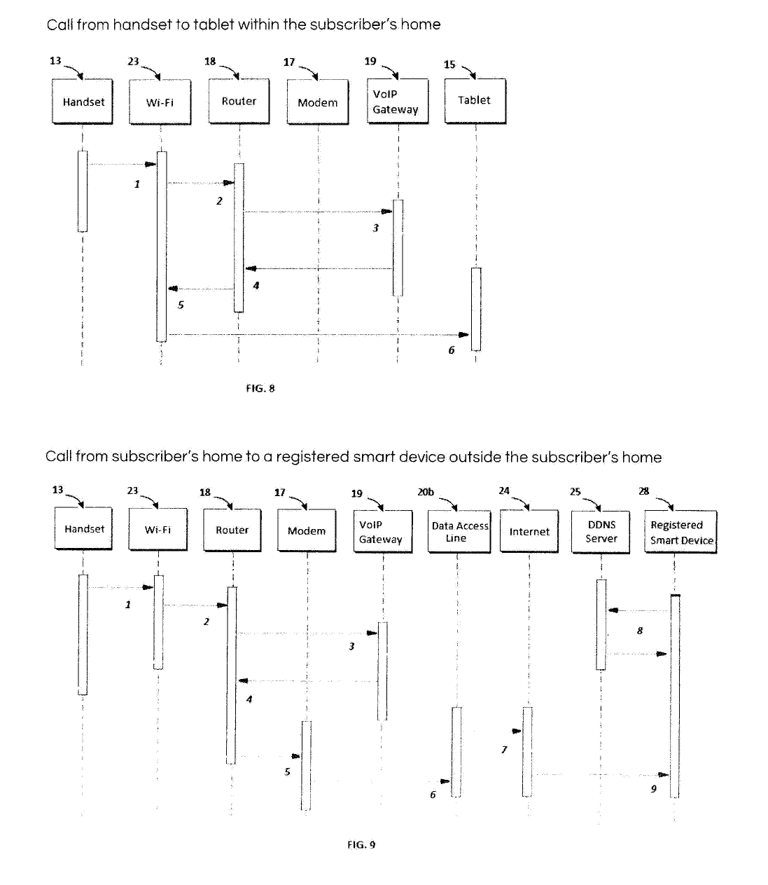

For a call from subscriber's home to PSTN as shown in FIGS. 3 and 7, the call from the handset 13 is sent via Wi-Fi 23 to the router 18. The router 18 sends the data packets to the VoIP gateway 19 which then sends the digital signal to the telephone interface module 22. The telephone interface module 22 converts the 31) digital signal into voice signal to be received by PSTN 20o (for easy reference, see the number of arrowheads 1-5).

For a call from handset to tablet within the subscriber's home as shown in FIGS. 3 and 8, the call from the handset 13 is sent via Wi-Fi 23 to the router 18. The router 18 forwards the data pockets to the VoIP gateway 19. The VoIP gateway 19 sends a response whether or not the call is possible. When such call is possible, connection between the handset 13 and tablet 15 is established via Wi-Fi 23 and the call is progressed. This use case also applies to smartphones and other smart devices when the sold devices are within the home and are wirelessly connected to the docking station (for easy reference, see the number of arrowheads 1-6).

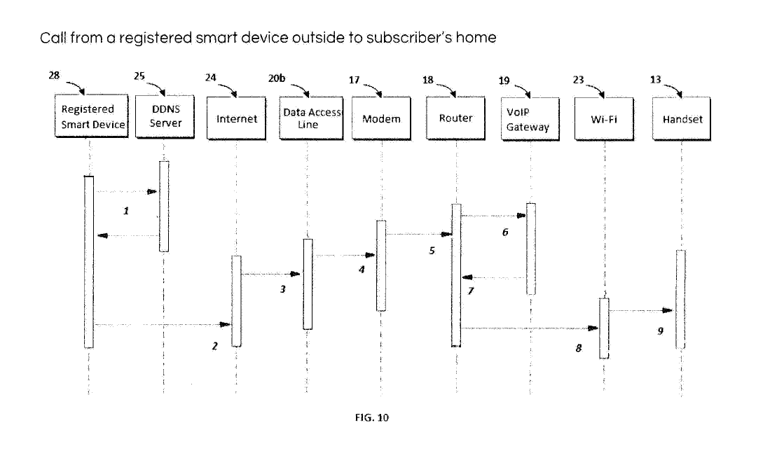

For a call from subscriber's home to a registered smart device outside the subscriber's home as shown in FIGS. 3 and 9, the call from the handset 13 is sent via Wi-Fi 23 to the router 18. The router 18 forwards the data packets to the VoIP gateway 19. The VoIP gateway 19 sends a response whether or not the call is possible. The VoIP gateway 19 sends the data back to the router 18 which forwards the data to the modem 17. The modem 17 converts the digital signal into a suitable signal to be sent to the Internet 24 via data access line 20b. The registered smart device 28 communicates with the DDNS server 25 to retrieve the IP address of the VoIP gateway 19. The call to the registered smart device 28 is progressed via the Internet 24. This use case also applies when another registered smart device within the home is used in place of the handset (for easy reference, see the number of arrowheads 1-9).

For a call from a registered smart device outside to subscriber's home as shown in FIGS. 3 and 10, the registered smart device 28 connects with the DDNS server 25 to retrieve the IP address of the VoIP gateway 19. The call from the registered smart device 28 is sent to the Internet 24. The modem 17 receives the data via data access line 20b and sends it to the router 18. The router 18 forwards the digital signal to the VoIP gateway 19. The VoIP gateway 19 sends a response whether or not the call is possible. The VoIP gateway 19 sends the data packets to the router 18 which forwards them to the handset 13 through Wi-Fi 23. The handset 13 receives the data packets and the call is progressed. This use case also applies when the receiving party is using the tablet 15 or another registered smart device that is within the home and is wirelessly connected to the docking station (for easy reference, see the number of arrowheads 1-9).

In the above use cases, a DDNS client 12 reports the IP address of the VoIP gateway 19 to the DDNS server 25. Also in the above use cases, the docking station 11 has a Local Area Network (LAN) port 30 to which a VoIP phone 31 or a computer 32 can be connected such that they can take the place of a registered smart device 28.

To extend landline voice service to another smart device, VoIP softphone 14 is downloaded in that smart device. VoIP softphone 14 gets its configuration information from the provisioning server 27. The provisioning server 27 has database of configuration settings for the VoIP softphone 14 to know as to which VoIP gateway 19 it should communicate with.

Referring to the block diagram as shown in FIG. 3 and the use cases as shown in FIGS. 4 to 10, a notification server 26 pushes calls and messages to the VoIP softphone 14 regardless of whether the VoIP softphone 14 is active or not at the time when the call or message was sent.

### Description of Docking Station Components

| | |
|---|---|
| Telephone | Receives and transmits voice signals. In case of |
| Interface Module | analog voice signals, the telephone interface |
| | module converts the analog signal into digital |
| | signal. In case of digital voice signals, the |
| | telephone interface module converts the digital |
| | signal from one format to another depending on |
| | the protocol being used. |
| Modem | Optional built-in component for the docking |
| | station to allow Internet connection through a |
| | telephone port such as RJ11 port. However, |
| | Internet connection can also be obtained by |
| | connecting on external modem to the WAN port |
| | using an RJ45 cable. |
| Wide Area Network | Connection point for Internet sources via RJ45 |
| (WAN) Port | connector |
| Router | Forwards data pockets along the network |
| Local Area Network | Connection point for VolP phone or computer |
| (LAN) Port | |
| VolP Gateway | Handles call setup and teardown |

### Description of Supporting Components

These components may not be physically part of the device itself but they play important roles in the functionality of the device. In the converged communication device of the present invention, the DDNS server is a key element in the solution as it helps establish the connection between the VoIP gateway and VoIP softphones. Meanwhile, the provisioning server is included to provide a hassle-free way of configuring the device. The notification server enables incoming calls and messages to be received even when the VoIP softphone in the registered smart device is not active at the time of sending.

| | |
|---|---|
| Dynamic Domain Name | Accepts and stores the IP address of VolP |
| System (DDNS) server | gateway to enable the registered smart device |
| | to locate the VolP gateway |
| Provisioning server | Stores configuration information to be retrieved |
| | by the VolP softphone for its initial registration |
| Notification server | Pushes messages and calls to the VolP |
| | softphone, regardless of whether the VolP |
| | softphone in the registered smart device is |
| | active or not at the time when the call or |
| | message was sent |

1. A converged communication device comprising:
a docking station that is connected to Public Switched Telephone Network (PSTN) via a telephone interface module at the back of said docking station;
a landline handset that is wirelessly connected to said docking station; and
a tablet computer that contains a software phone application and is wirelessly connected also to said docking station characterized in that:
said software phone application that is installed in said tablet computer can also be installed in other smart devices, such as smartphones and other tablet computers, to turn such devices into landline extensions that can make and receive landline calls beyond the confines of the home through the Internet;
said docking station includes a gateway switch that converts landline calls to Voice over Internet Protocol (VoIP) and allows the docking station to route calls to and from landline extensions, such as landline handset, tablet computer, and other smart devices that were made landline extensions; and
said docking station further includes an Internet Protocol (IP) router that allows the docking station to use Dynamic Domain Name System (DONS) or Network Address Translation (NAT) traversal techniques so that smart devices to which the software phone application is installed con find the IP address of the docking station when the tablet computer or other smart devices having Internet access are used outside the home.

2. The converged communication device of claim 1, wherein said telephone interface module is a Foreign eXchange Office (FXO) port for Plain Old Telephone Service (POTS).

3. The converged communication device of claim 1, wherein said docking station uses a wireless means to bridge a call originating from the landline handset or tablet computer to PSTN, and vice versa.

4. The converged communication device of claim 1, wherein said gateway switch of said docking station facilitates the exchange of calls between landline extensions, such as landline handset, tablet computer, and other smart devices to which the software phone application is installed.

5. The converged communication device of claim 1, wherein said IP router reports the IP address of the gateway switch to a DONS server so that the software phone application can find the IP address of the docking station.

6. The converged communication device of claim 1, wherein said docking station has the configuration information for each of the landline extensions, and forwards said configuration information to a provisioning server.

7. The converged communication device of claim 6, wherein said configuration information stored in the provisioning server is retrieved by said software phone application to allow it to be identified as a landline extension by the gateway switch.

8. The converged communication device of claim 1, wherein said docking station includes a Wide Area Network (WAN) port that enables connection to the Internet and allows the connection of an external modem in case of opting not to use the built-in internal modem.
